(19) United States
(12) Patent Application Publication
(10) Pub. No.: US 2025/0119038 A1
(43) Pub. Date: Apr. 10, 2025

(54) METHOD OF MANUFACTURING COMPACT, METHOD OF MANUFACTURING STATOR CORE, AND METHOD OF MANUFACTURING AXIAL GAP MOTOR

(71) Applicants: Sumitomo Electric Industries, Ltd., Osaka-shi, Osaka (JP); Sumitomo Electric Sintered Alloy, Ltd., Takahashi-shi, Okayama (JP)

(72) Inventors: Tatsuya SAITO, Osaka-shi, Osaka (JP); Masaaki EIDA, Takahashi-shi, Okayama (JP)

(73) Assignees: Sumitomo Electric Industries, Ltd., Osaka-shi, Osaka (JP); Sumitomo Electric Sintered Alloy, Ltd., Takahashi-shi, Okayama (JP)

(21) Appl. No.: 18/730,815

(22) PCT Filed: Nov. 13, 2023
(86) PCT No.: PCT/JP2023/040709

§ 371 Date: Jul. 22, 2024

(30) Foreign Application Priority Data
Nov. 24, 2022 (JP) 2022-187837

(51) Int. Cl. H02K 15/027; H02K 1/14; H02K 15/022; H02K 21/24

(52) U.S. Cl. CPC H02K 15/027; H02K 15/022; H02K 1/146; H02K 21/24

(57) ABSTRACT

A method of manufacturing a compact includes filling a space defined by a die hole in a die and a lower punch with powder, and compressing the powder in the space with the lower punch and an upper punch to form a compact. The compact includes a body, the body being prism-shaped and having a first bottom surface, a second bottom surface opposite to the first bottom surface, and a plurality of side surfaces, a first plate portion provided on the first bottom surface, and a second plate portion provided on the second bottom surface.

### TECHNICAL FIELD

The present disclosure relates to a method of manufacturing a compact, a method of manufacturing a stator core, and a method of manufacturing an axial gap motor. The present application claims priority based on Japanese Patent Application No. 2022-187837 filed on Nov. 24, 2022, the entire contents of which are incorporated herein.

### BACKGROUND ART

PTL 1 describes a core piece to be included in a stator core of an axial gap rotary electric machine. The core piece includes a column-shaped body extending along an axis of the stator core, a first plate portion that is plate-shaped and provided at a first end of the body, and a second plate portion that is plate-shaped and provided at a second end of the body. Each of the first plate portion and the second plate portion includes a projecting section projecting outward beyond a peripheral surface of the body.

The body, the first plate portion, and the second plate portion that constitute the core piece are formed integrally by compressing powder with a mold including a die, a lower punch, and an upper punch. This can be achieved by compressing the powder with the mold and removing the core piece, which is a compact, from the mold in a direction along a diameter of the stator core.

In general, a compact including the above-described projecting sections at both ends of the body cannot be formed by compressing powder in a direction along the axis of the stator core. This is because the projecting sections at both ends of the body serve as undercuts that project in directions crossing the direction in which the compact is removed from the mold. According to the above-described method of forming a compact, the compact including the above-described projecting sections at both ends of the body can be manufactured without dividing a member of the mold or forming at least one of the body, the first plate portion, and the second plate portion using another mold.

### CITATION LIST

### Patent Literature

PTL 1: WO 2021/225049

### SUMMARY OF INVENTION

A method of manufacturing a compact according to the present disclosure includes filling a space defined by a die hole in a die and a lower punch with powder, and compressing the powder in the space with the lower punch and an upper punch to form a compact. The compact includes a body, the body being prism-shaped and having a first bottom surface, a second bottom surface opposite to the first bottom surface, and a plurality of side surfaces, a first plate portion provided on the first bottom surface, and a second plate portion provided on the second bottom surface. The plurality of side surfaces include a front surface and a rear surface, the front surface and the rear surface extending parallel to each other along an axis of the body, and a left side surface and a right side surface, the left side surface connecting the front surface and the rear surface, the right side surface connecting the front surface and the rear surface. The first plate portion includes a first projecting section projecting from the body in a direction orthogonal to the axis, a first front surface and a first rear surface, the first front surface and the first rear surface extending parallel to each other along the axis, and a first left side surface and a first right side surface, the first left side surface connecting the first front surface and the first rear surface, the first right side surface connecting the first front surface and the first rear surface. The first left side surface and the first right side surface include oblique regions in which a gap between the first left side surface and the first right side surface increases from the first front surface toward the first rear surface. The second plate portion includes a second projecting section projecting from the body in a direction orthogonal to the axis, a second front surface and a second rear surface, the second front surface and the second rear surface extending parallel to each other along the axis, and a second left side surface and a second right side surface, the second left side surface connecting the second front surface and the second rear surface, the second right side surface connecting the second front surface and the second rear surface. The upper punch includes a main lower surface configured to form the left side surface of the body, a first sub-lower surface configured to form the first left side surface of the first plate portion, and a second sub-lower surface configured to form the second left side surface of the second plate portion. The lower punch includes a main upper surface configured to form the right side surface of the body, a first sub-upper surface configured to form the first right side surface of the first plate portion, and a second sub-upper surface configured to form the second right side surface of the second plate portion.

### BRIEF DESCRIPTION OF DRAWINGS

FIG. 1 is a perspective view, viewed obliquely from the front, of a compact formed by a method of manufacturing a compact according to a first embodiment.

FIG. 2 is a perspective view, viewed obliquely from the rear, of the compact formed by the method of manufacturing a compact according to the first embodiment.

FIG. 3 is a cross-sectional view of a die used in the method of manufacturing a compact according to the first embodiment.

FIG. 4 is a vertical sectional view of a body taken along direction W when the body is compressed in a mold in the method of manufacturing a compact according to the first embodiment.

FIG. 5 is a vertical sectional view of a first plate portion of a compact taken along direction W when the compact is compressed in the mold in the method of manufacturing a compact according to the first embodiment.

FIG. 6 is a vertical sectional view of the compact in the mold taken along direction D when the compact is molded in the method of manufacturing a compact according to the first embodiment.

FIG. 7 is a plan view of a stator core of an axial gap motor constituted by compacts structured as illustrated in FIG. 1.

FIG. 8 is a vertical sectional view of an axial gap motor including the stator core illustrated in FIG. 7.

FIG. 9 is a vertical sectional view of another axial gap motor including the stator core illustrated in FIG. 7.

### DETAILED DESCRIPTION

### Problems to be Solved by Present Disclosure

The compact including the projecting sections as described in the Background Art section is desirably formed to minimize chipping and cracking. In the above-described method of forming a compact, a surface of the core piece, or a compact, configured to constitute an inner peripheral surface of an annular stator core is pressed by the lower punch, and a surface of the core piece configured to constitute an outer peripheral surface of the annular stator core is pressed by the upper punch. The surface configured to constitute the inner peripheral surface is narrower than the surface configured to constitute the outer peripheral surface, and accordingly the lower punch is narrower than the upper punch. Thus, when the compact is removed from the mold, the compact is locally pressed by the lower punch. As a result, the compact receives a shear stress, and depending on the shape or dimensions of the compact, chipping or cracking of the molded body may occur at a boundary between a portion that is pressed by the lower punch and a portion that is not pressed by the lower punch.

An object of the present disclosure is to provide a method of manufacturing a compact with which damage to the compact can be reduced. Another object of the present disclosure is to provide a method of manufacturing a stator core using compacts formed by the above-described method of manufacturing a compact.

### Advantageous Effects of Present Disclosure

According to the method of manufacturing a compact of the present disclosure, damage to the compact can be reduced.

### Description of Embodiments of Present Disclosure

Embodiments of the present disclosure will now be described.

<1> A method of manufacturing a compact according to an embodiment includes filling a space defined by a die hole in a die and a lower punch with powder, and compressing the powder in the space with the lower punch and an upper punch to form a compact. The compact includes a body, the body being prism-shaped and having a first bottom surface, a second bottom surface opposite to the first bottom surface, and a plurality of side surfaces, a first plate portion provided on the first bottom surface, and a second plate portion provided on the second bottom surface. The plurality of side surfaces include a front surface and a rear surface, the front surface and the rear surface extending parallel to each other along an axis of the body, and a left side surface and a right side surface, the left side surface connecting the front surface and the rear surface, the right side surface connecting the front surface and the rear surface. The first plate portion includes a first projecting section projecting from the body in a direction orthogonal to the axis, a first front surface and a first rear surface, the first front surface and the first rear surface extending parallel to each other along the axis, and a first left side surface and a first right side surface, the first left side surface connecting the first front surface and the first rear surface, the first right side surface connecting the first front surface and the first rear surface. The first left side surface and the first right side surface include oblique regions in which a gap between the first left side surface and the first right side surface increases from the first front surface toward the first rear surface. The second plate portion includes a second projecting section projecting from the body in a direction orthogonal to the axis, a second front surface and a second rear surface, the second front surface and the second rear surface extending parallel to each other along the axis, and a second left side surface and a second right side surface, the second left side surface connecting the second front surface and the second rear surface, the second right side surface connecting the second front surface and the second rear surface. The upper punch includes a main lower surface configured to form the left side surface of the body, a first sub-lower surface configured to form the first left side surface of the first plate portion, and a second sub-lower surface configured to form the second left side surface of the second plate portion. The lower punch includes a main upper surface configured to form the right side surface of the body, a first sub-upper surface configured to form the first right side surface of the first plate portion, and a second sub-upper surface configured to form the second right side surface of the second plate portion.

According to the above-described method of manufacturing a compact, damage to the compact, such as chipping or cracking, can be reduced. The compact obtained by this manufacturing method is shaped such that the first projecting section and the second projecting section project from the body. The compact having such a shape can be molded by pressing the left side surface, the first left side surface, the second left side surface, the right side surface, the first right side surface, and the second right side surface of the compact with the upper punch and the lower punch. In the molding process, the first plate portion and the second plate portion having the projecting sections are positioned such that the left side surface, the first left side surface, the second left side surface, the right side surface, the first right side surface, and the second right side surface are in upper and lower regions of the die hole. The front surface, the first front surface, the second front surface, the rear surface, the first rear surface, and the second rear surface are at the front and rear of the die hole. The compact can be compressed with the upper punch and the lower punch over the entire width of the compact. Since the lower punch does not locally press the compact when the compact is removed from the mold, chipping and cracking of the compact can be reduced compared to when the method of forming a compact disclosed in PTL 1 is used.

<2> In the method of manufacturing a compact according to <1>, the left side surface and the right side surface may be oblique such that a gap between the left side surface and the right side surface increases from the front surface toward the rear surface.

According to the above-described method of manufacturing a compact, a compact in which the left and right side surfaces of the body are oblique can be obtained. When not only the first plate portion but also the body has oblique surfaces, a coil can be easily provided on the outer periphery of the body such that the outer shape of the coil matches the outer shape of the first plate portion. In other words, when the compact is used to form a magnetic member, such as a stator core of a motor, the dead space in the motor can be reduced.

<3> In the method of manufacturing a compact according to <1> or <2>, the second left side surface and the second right side surface may include oblique regions in which a gap between the second left side surface and the second right side surface increases from the second front surface toward the second rear surface.

According to the above-described method of manufacturing a compact, a compact in which not only the first plate portion but also the second plate portion has the second left side surface and the second right side surface that are oblique can be obtained. When the second plate portion also has oblique surfaces, the second plate portion can be easily formed such that the shape thereof matches the shape of the first plate portion. When the coil is provided on the outer periphery of the body, both end portions of the coil can be evenly held by the first plate portion and the second plate portion.

<4> In the method of manufacturing a compact according to any one of <1> to <3>, the first projecting section may project from the body over an entire periphery of the body around the axis.

According to the above-described method of manufacturing a compact, a compact shaped such that the first projecting section project from the body over the entire periphery of the body can be obtained. When the coil is provided on the outer periphery of the body, a first end portion of the coil can be abutted against the first projecting section over the entire periphery thereof.

<5> In the method of manufacturing a compact according to any one of <1> to <4>, the second projecting section may project from the body over an entire periphery of the body around the axis.

According to the above-described method of manufacturing a compact, a compact shaped such that the second projecting section project from the body over the entire periphery of the body can be obtained. When the coil is provided on the outer periphery of the body, a second end portion of the coil can be abutted against the second projecting section over the entire periphery thereof.

<6> In the method of manufacturing a compact according to any one of <1> to <5>, the powder may be magnetic powder.

According to the above-described method of manufacturing a compact, since the compact is formed using the magnetic powder, a dust core, such as a stator core of a motor or a core of a reactor, can be obtained.

<7> A method of manufacturing a stator core according to an embodiment includes manufacturing a plurality of compacts by the method of manufacturing a compact according to any one of <1> to <6>, and forming an annular stator core by arranging the plurality of compacts such that adjacent ones of the plurality of compacts have the first left side surface and the first right side surface facing parallel to each other.

According to the above-described method of manufacturing a stator core, a stator core of an axial gap motor, for example, can be formed by assembling the compacts into an annular form.

<8> A method of manufacturing an axial gap motor according to an embodiment includes manufacturing a stator core by the method of manufacturing a stator core according to <7>, and assembling the stator core and a rotor together.

### Details of Embodiments of Present Disclosure

A method of manufacturing a compact according to an embodiment of the present disclosure will be described. Before describing the method of manufacturing a compact, the structure of a compact obtained by the manufacturing method will be described. Next, the method of manufacturing a compact will be described. Lastly, a method of manufacturing a stator core using the compact, and an axial gap motor including the stator core will be described. In the drawings, the same reference signs denote the same or corresponding components. In the drawings, the members are drawn in sizes suitable for clear description, and are not necessarily to scale.

### <<Compact>>

The above-described compact will be described by referring to a core piece to be included in a stator core of an axial gap motor as an example. The stator core has an annular structure constituted by core pieces.

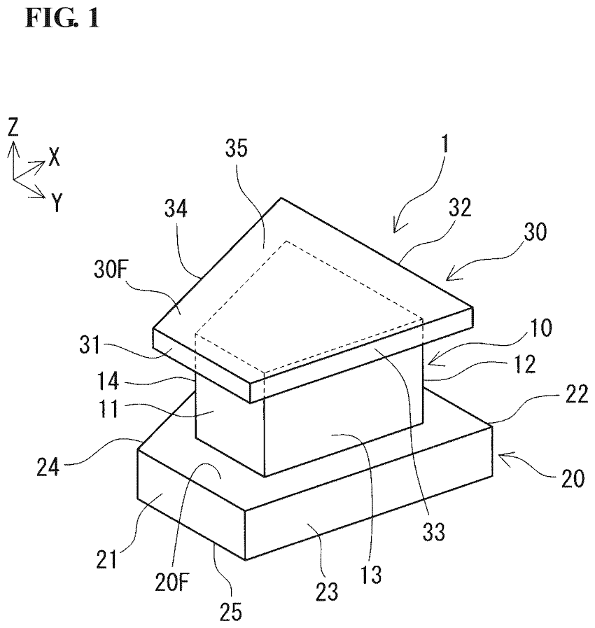

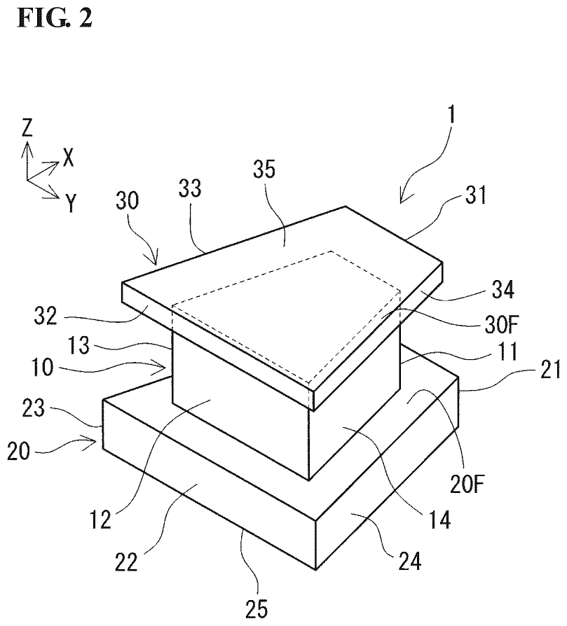

As illustrated in FIGS. 1 and 2, a compact 1 includes a body 10, a first plate portion 20, and a second plate portion 30. The body 10 is prism-shaped. The first plate portion 20 is provided at a first end of the body 10 in a direction along an axis of the body 10. The second plate portion 30 is provided at a second end of the body 10 in the direction along the axis of the body 10. The first plate portion 20 includes a first projecting section 20F, and the second plate portion 30 includes a second projecting section 30F. The body 10, the first plate portion 20, and the second plate portion 30 are formed integrally. The phrase “formed integrally” means that the body 10, the first plate portion 20, and the second plate portion 30 are seamlessly connected by being molded together, and are not mechanically connected with a screw or the like or bonded with an adhesive or the like.

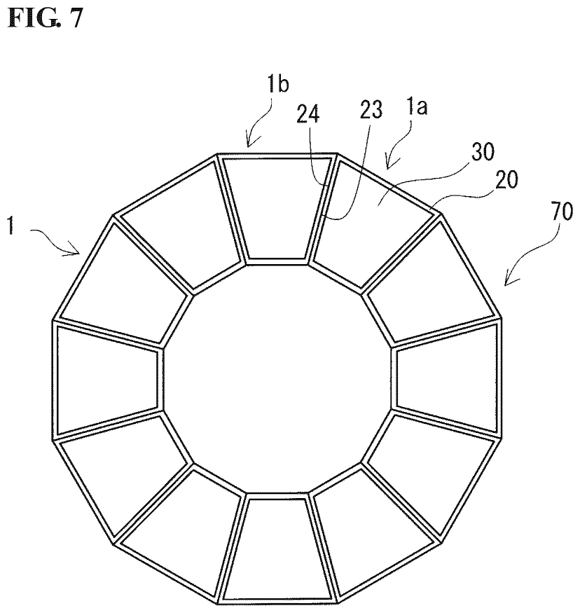

The directions of the compact 1 are defined as described below. The directions of the compact 1 are shown by arrows in FIGS. 1, 2, and 4 to 6. The stator core will be described with reference to FIG. 7.

The direction of the compact 1 along a diameter of a stator core 70 is direction X.

The direction of the compact 1 along an axis of the stator core 70 is direction Z. Direction Z is the direction along the axis of the body 10.

The direction of the compact 1 orthogonal to both direction X and direction Z is direction Y.

In the following description, the inner side and the outer side of the annular stator core are the front and the rear, respectively, and the left and right are defined as those when viewed in the front-to-rear direction. Alternatively, however, the outer side and the inner side of the stator core may be the front and the rear, respectively, and the left and right may be defined as those when viewed in the front-to-rear direction.

The structure of the compact will now be described in detail.

[Body]

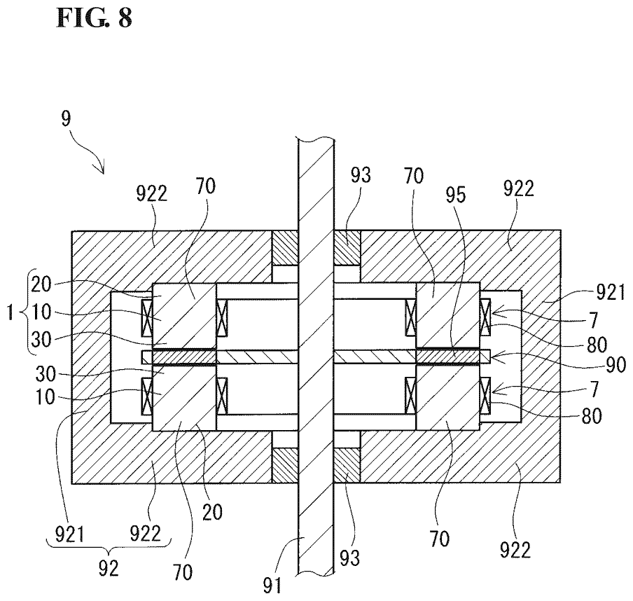

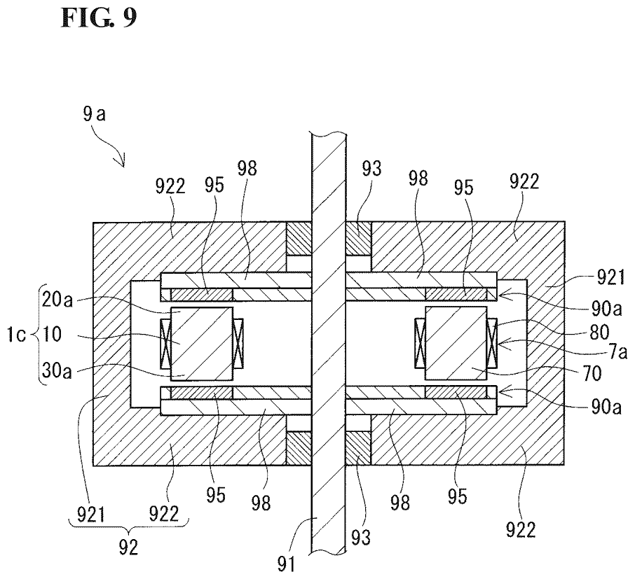

The body 10 is a column-shaped member that extends in direction Z. The body 10 constitutes a tooth both when the compact 1 is included in each stator core 70 of an axial gap motor 9 of a double-stator single-rotor type and when the compact 1 is included in the stator core 70 of an axial gap motor 9 of a single-stator double-rotor type. Referring to FIG. 8, a double-stator single-rotor axial gap motor 9 includes a single rotor 90 sandwiched between two stators 7. As illustrated in FIG. 9, a single-stator double-rotor axial gap motor 9a includes a single stator 7a sandwiched between two rotors 90a. For convenience of description, double-stator single-rotor may be abbreviated as DS/SR, and single-stator double-rotor may be abbreviated as SS/DR.

The body 10 has a prism shape. The prism shape is, for example, the shape of a quadrangular column having a quadrangular shape in cross-section taken along a plane orthogonal to direction Z. Here, the quadrangular shape is not limited to the shape of a quadrangle in a strict geometrical sense, and includes shapes obtained by connecting four corners in cross-section. More specifically, the quadrangular shape includes the shapes of slightly deformed quadrangles, for example, shapes having the four corners rounded or chamfered in cross-section. The quadrangles include rectangles and trapezoids. The rectangles include elongated rectangles and squares. The trapezoids include trapezoids having legs of the same length, such as isosceles trapezoids, and right trapezoids. The above-described cross-sectional shape may be constant in direction Z. The above discussion applies also to the first plate portion 20 and the second plate portion 30 described below.

As illustrated in FIGS. 1, 2, and 4, the body 10 has the shape of, for example, a trapezoid column having a trapezoidal shape in cross-section as described above. The body 10 has a constant cross-sectional shape in direction Z. When the body 10 has the shape of a trapezoidal column, an annular stator core can be easily formed, and the area of the magnetic path can be easily increased. In addition, the dead space of the compact 1 can be easily reduced, and the space factor of each stator 7 can be easily increased.

As illustrated in FIGS. 1 and 2, the body 10 has a peripheral surface connected to the first plate portion 20 and the second plate portion 30. The peripheral surface includes a front surface 11, a rear surface 12, a right side surface 13, and a left side surface 14. The front surface 11, the rear surface 12, the right side surface 13, and the left side surface 14 are all flat. The front surface 11 and the rear surface 12 extend along the axis of the body 10. The front surface 11 and the rear surface 12 extend along direction Z. The front surface 11 and the rear surface 12 also extend along direction Y. The front surface 11 and the rear surface 12 face parallel to each other. The front surface 11 and the rear surface 12 have, for example, rectangular shapes. The direction from the front surface 11 toward the rear surface 12 is a direction along a diameter of the stator core 70. The front surface 11 is closer to the axis of the stator core 70 than the rear surface 12. The dimension of the front surface 1I in direction Y is less than the dimension of the rear surface 12 in direction Y. The area of the front surface 11 is less than the area of the rear surface 12.

The right side surface 13 connects the right sides of the front surface 11 and the rear surface 12. The left side surface 14 connects the left sides of the front surface 11 and the rear surface 12. The right side surface 13 and the left side surface 14 both have rectangular shapes, and the areas thereof are equal. The right side surface 13 and the left side surface 14 are oblique surfaces that non-orthogonally cross direction X. The gap between the right side surface 13 and the left side surface 14 increases from the front surface 11 toward the rear surface 12. The right side surface 13 and the left side surface 14 are at the same angle relative to direction X. In other words, the right side surface 13 and the left side surface 14 are symmetric about a line segment extending in direction X. A crossing angle between an extension of the right side surface 13 and an extension of the left side surface 14 is, for example, 5° to 40°. When the body 10 also has oblique surfaces, a coil can be easily provided on the outer periphery of the body 10 such that the outer shape of the coil matches the outer shape of the first plate portion 20.

### [First Plate Portion]

As illustrated in FIGS. 1, 2, 8, and 9, the first plate portion 20 is provided at the first end of the body 10 in direction Z. When the compact 1 is included in each stator core 70 of the DS/SR axial gap motor 9, the first plate portion 20 constitutes a yoke. When the compact 1 is included in the stator core 70 of the SS/DR axial gap motor 9a, the first plate portion 20a constitutes a flange portion.

The first plate portion 20 has the shape of, for example, a trapezoidal plate. The shape of a trapezoidal plate is a shape such that the first plate portion 20 has a trapezoidal cross-sectional shape along a plane orthogonal to direction Z. The cross-sectional shape is constant in direction Z. When the compact 1 is included in the stator core 70 of the SS/DR axial gap motor 9a, the first plate portion 20a may have the shape of a rectangular plate.

The first plate portion 20 includes a first front surface 21, a first rear surface 22, a first right side surface 23, a first left side surface 24, and a first end surface 25. The first front surface 21, the first rear surface 22, the first right side surface 23, the first left side surface 24, and the first end surface 25 are all flat. The first front surface 21 and the first rear surface 22 extend along the axis of the body 10. The first front surface 21 and the first rear surface 22 extend along direction Z. The first front surface 21 and the first rear surface 22 also extend along direction Y The first front surface 21 and the first rear surface 22 face parallel to each other. The first front surface 21 and the first rear surface 22 have, for example, flat rectangular shapes. The direction from the first front surface 21 toward the first rear surface 22 is the direction along the diameter of the stator core 70. The first front surface 21 is closer to the axis of the stator core 70 than the first rear surface 22. The dimension of the first front surface 21 in direction Y is less than the dimension of the first rear surface 22 in direction Y. The area of the first front surface 21 is less than the area of the first rear surface 22.

The first right side surface 23 connects the right sides of the first front surface 21 and the first rear surface 22. The first left side surface 24 connects the left sides of the first front surface 21 and the first rear surface 22. The first right side surface 23 and the first left side surface 24 both have, for example, rectangular shapes, and the areas thereof are equal. The first right side surface 23 and the first left side surface 24 are, for example, oblique surfaces that non-orthogonally cross direction X. The gap between the first right side surface 23 and the first left side surface 24 increases from the first front surface 21 toward the first rear surface 22. The first right side surface 23 and the first left side surface 24 are at the same angle relative to direction X. In other words, the first right side surface 23 and the first left side surface 24 are symmetric about a line segment extending in direction X. The first plate portion 20 having the oblique surfaces as described above facilitates the manufacture of the fan-shaped compact 1. The oblique surfaces of the first right side surface 23 and the first left side surface 24 may each have a region parallel to direction X at least at one of the ends thereof in direction X. When the parallel regions are provided, the first plate portion 20 does not have corners with acute angles. The crossing angle between an extension of the first right side surface 23 and an extension of the first left side surface 24 is, for example, 5° to 40°. The crossing angle may be the same as or different from the crossing angle between the extension of the right side surface 13 and the extension of the left side surface 14. In one example of the compact 1, the crossing angle between the extension of the first right side surface 23 and the extension of the first left side surface 24 is the same as the crossing angle between the extension of the right side surface 13 and the extension of the left side surface 14. The first right side surface 23 and the right side surface 13 are parallel. The first left side surface 24 and the left side surface 14 are parallel. The first end surface 25 is a surface orthogonal to direction Z. The first end surface 25 constitutes, for example, the bottom surface of the compact 1.

The first plate portion 20 includes a first projecting section 20F. The first projecting section 20F projects outward from the peripheral surface of the body 10. The first projecting section 20F may project outward from the peripheral surface of the body 10 in a partial region of the peripheral surface of the body 10. Alternatively, the first projecting section 20F may project outward from the peripheral surface of the body 10 over the entire periphery of the peripheral surface of the body 10. In one example, the first projecting section 20F projects outward from the peripheral surface of the body 10 over the entire periphery of the peripheral surface of the body 10. The first projecting section 20F is trapezoidal frame-shaped. The trapezoidal frame-shaped first projecting section 20F has a peripheral surface that defines the first front surface 21, the first rear surface 22, the first right side surface 23, and the first left side surface 24. According to this structure, the coil may be provided on the outer periphery of the body 10 such that a first end portion of the coil is abutted against and stopped by the first projecting section 20F over the entire periphery thereof. Unlike this example, the first projecting section 20F may be structured to project outward from at least one of the front surface 11, the rear surface 12, the right side surface 13, and the left side surface 14 of the body 10. When the first projecting section 20F projects outward from the peripheral surface of the body 10 in a partial region of the peripheral surface of the body 10, one or more of the first front surface 21, the first rear surface 22, the first right side surface 23, and the first left side surface 24 may be flush with the peripheral surface of the body 10.

The protrusion length by which the first projecting section 20F projects from the body 10 may be selected as appropriate. When the compact 1 is used to form each stator core 70 provided in the DS/SR axial gap motor 9, the protrusion length of the first projecting section 20F from the peripheral surface of the body 10 is greater than the protrusion length of the second projecting section 30F described below from the body 10. According to this structure, when core pieces are arranged next to each other to form an annular stator core, the first projecting sections 20F, which constitute a yoke, can be brought into contact with each other while the second projecting sections 30F, which constitute a flange portion, have gaps therebetween. When the compact 1 is used to form the stator core 70 provided in SS/DR axial gap motor 9, the protrusion length of the first projecting section 20F may be the same as the protrusion length of the second projecting section 30F described below from the peripheral surface of the body 10. The protrusion length is a length in a direction orthogonal to the peripheral surface of the body 10. When the peripheral surface is curved, the protrusion length refers to a length along a normal direction of the curved surface.

### [Second Plate Portion]

As illustrated in FIGS. 1, 2, 8, and 9, the second plate portion 30 is provided at the second end of the body 10 in direction Z. Both when the compact 1 is included in each stator core 70 of the DS/SR axial gap motor 9 and when the compact 1 is included in the stator core 70 of the SS/DR axial gap motor 9a, the second plate portion 30, 30a constitutes a flange portion.

The second plate portion 30 has the shape of, for example, a trapezoidal plate. The shape of a trapezoidal plate is a shape such that the second plate portion 30 has a trapezoidal cross-sectional shape along a plane orthogonal to direction Z. The cross-sectional shape is constant in direction Z. When the compact 1 is included in the stator core 70 of the SS/DR axial gap motor 9a, the second plate portion 30a may have the shape of a rectangular plate.

The second plate portion 30 includes a second front surface 31, a second rear surface 32, a second right side surface 33, a second left side surface 34, and a second end surface 35. The second front surface 31, the second rear surface 32, the second right side surface 33, the second left side surface 34, and the second end surface 35 are all flat. The second front surface 31 and the second rear surface 32 extend along the axis of the body 10. The second front surface 31 and the second rear surface 32 extend along direction Z. The second front surface 31 and the second rear surface 32 also extend along direction Y The second front surface 31 and the second rear surface 32 face parallel to each other. The second front surface 31 is flush with the first front surface 21. The second rear surface 32 is flush with the first rear surface 22. The second front surface 31 and the first front surface 21 are not necessarily flush with each other. The second rear surface 32 and the first rear surface 22 are not necessarily flush with each other. The second front surface 31 is not flush with the front surface 11. The second rear surface 32 is not flush with the rear surface 12. The second front surface 31 may be flush with the front surface 1. The second rear surface 32 may be flush with the rear surface 12. The second front surface 31 and the second rear surface 32 have, for example, flat rectangular shapes. In one example of the second plate portion 30, the second front surface 31 and the second rear surface 32 have a thickness (length in direction Z) less than the thickness of the first front surface 21 and the first rear surface 22. However, the second front surface 31 and the second rear surface 32 may have a thickness equal to the thicknesses of the first front surface 21 and the first rear surface 22. The direction from the second front surface 31 toward the second rear surface 32 is the direction along the diameter of the stator core 70. The second front surface 31 is closer to the axis of the stator core 70 than the second rear surface 32. The dimension of the second front surface 31 in direction Y is less than the dimension of the second rear surface 32 in direction Y The area of the second front surface 31 is less than the area of the second rear surface 32.

The second right side surface 33 connects the right sides of the second front surface 31 and the second rear surface 32. The second left side surface 34 connects the left sides of the second front surface 31 and the second rear surface 32. The second right side surface 33 and the second left side surface 34 both have, for example, rectangular shapes, and the areas thereof are equal. The second right side surface 33 and the second left side surface 34 are, for example, oblique surfaces that non-orthogonally cross direction X. The gap between the second right side surface 33 and the second left side surface 34 increases from the second front surface 31 toward the second rear surface 32. The second right side surface 33 and the second left side surface 34 are at the same angle relative to direction X. The second right side surface 33 and the second left side surface 34 are symmetric about a line segment extending in direction X. The second plate portion 30 having the oblique surfaces as described above facilitates the manufacture of the fan-shaped compact 1. The oblique surfaces of the second right side surface 33 and the second left side surface 34 may each have a region parallel to direction X at least at one of the ends thereof in direction X. When the regions parallel to direction X are provided, the second plate portion 30 does not have corners with acute angles on the second rear surface 32. When the regions parallel to direction X are provided at both ends, the difference in compression ratio between the region including the second front surface 31 and the region including the second rear surface 32 of the second plate portion 30 can be reduced in the manufacturing process. The crossing angle between an extension of the second right side surface 33 and an extension of the second left side surface 34 is, for example, 5° to 40°. The crossing angle may be the same as or different from the crossing angle between the extension of the right side surface 13 and the extension of the left side surface 14. In one example of the compact 1, the crossing angle between the extension of the second right side surface 33 and the extension of the second left side surface 34 is the same as the crossing angle between the extension of the right side surface 13 and the extension of the left side surface 14. The second right side surface 33 and the right side surface 13 are parallel. The second left side surface 34 and the left side surface 14 are parallel. The second right side surface 33 is not necessarily parallel with the first right side surface 23. The second right side surface 33 is not necessarily flush with the first right side surface 23. The second left side surface 34 is not necessarily parallel with the first left side surface 24. The second left side surface 34 is not necessarily flush with the first left side surface 24. The second end surface 35 is a surface orthogonal to direction Z. The second end surface 35 constitutes, for example, the top surface of the compact 1.

The second plate portion 30 includes a second projecting section 30F. The second projecting section 30F projects outward from the peripheral surface of the body 10. The second projecting section 30F may project outward from the peripheral surface of the body 10 in a partial region of the peripheral surface of the body 10. Alternatively, the second projecting section 30F may project outward from the peripheral surface of the body 10 over the entire periphery of the peripheral surface of the body 10. In one example, the second projecting section 30F projects outward from the peripheral surface of the body 10 over the entire periphery of the peripheral surface of the body 10. The second projecting section 30F is trapezoidal frame-shaped. The trapezoidal frame-shaped second projecting section 30F has a peripheral surface that defines the second front surface 31, the second rear surface 32, the second right side surface 33, and the second left side surface 34. According to this structure, the coil may be provided on the outer periphery of the body 10 such that a second end portion of the coil is abutted against and stopped by the second projecting section 30F over the entire periphery thereof. Unlike this example, the second projecting section 30F may be structured to project outward from at least one of the front surface 11, the rear surface 12, the right side surface 13, and the left side surface 14 of the body 10. When the second projecting section 30F projects outward from the peripheral surface of the body 10 in a partial region of the peripheral surface of the body 10, one or more of the second front surface 31, the second rear surface 32, the second right side surface 33, and the second left side surface 34 may be flush with the peripheral surface of the body 10.

### [Material]

The compact 1 is formed of powder containing magnetic powder. The magnetic powder includes magnetic particles. The magnetic particles may be, for example, soft magnetic particles. The compact 1 may be formed by, for example, compression molding using soft magnetic powder including soft magnetic particles. The soft magnetic particles include iron-based particles made of pure iron or an iron-based alloy. Pure iron is iron (Fe) with a purity of 99 mass % or more. The iron-based alloy contains, for example, at least one of silicon (Si) and aluminum (Al) with the balance being Fe and unavoidable impurities. The iron-based alloy may be selected from a group composed of Fe—Si-based alloy, Fe—Al-based alloy, and Fe—Si—Al-based alloy. The Fe—Si-based alloy may be, for example, silicon steel. The Fe—Si—Al-based alloy may be, for example, Sendust. The material of the compact 1 may include different types of soft magnetic particles. The above-described iron-based particles are relatively soft, and therefore deformation of the soft magnetic particles easily occurs when the compact 1 is molded. Accordingly, the compact 1 has a high density and a high dimensional accuracy. When the compact 1 is composed of a collection of coated soft magnetic particles that are soft magnetic particles having surfaces with insulating coating, loss can be reduced. The compact 1 may be formed by compression molding using coated soft magnetic powder including coated soft magnetic particles. When insulating coating is formed, the insulating coating increases electrical insulation between the particles. Therefore, the iron loss of the compact 1 due to eddy current loss can be reduced. Examples of soft magnetic particles are described above. The insulating coating may be, for example, phosphate coating or silica coating.

### [Relative Density]

The relative density of the compact 1 may be 85% or more. The compact 1 having a relative density of 85% or more has good magnetic characteristics, such as saturation magnetic flux density, and good mechanical properties, such as strength. The relative density of the compact 1 may be 90% or more, or 93% or more. The relative density of the compact 1 may be less than 100%. The “relative density” means the ratio (%) of the actual density of the compact 1 to the true density of the soft magnetic particles that form the compact 1.

The “relative density of a dust core” is the ratio (%) of the actual density of the dust core to the true density of the dust core. The relative density of the dust core can be calculated as [(actual density of dust core/true density of dust core)×100]. The actual density of the dust core can be determined by immersing the dust core in oil so that the dust core is impregnated with oil and calculating [oil-impregnated density×(mass of dust core before impregnation with oil/mass of dust core after impregnation with oil)]. The oil-impregnated density is (mass of dust core after impregnation with oil/volume of dust core after impregnation with oil). The actual density of the dust core can be obtained as (mass of dust core before impregnation with oil/volume of dust core after impregnation with oil). The volume of the dust core after impregnation with oil can typically be measured by the liquid displacement method. The true density of the dust core is a theoretical density assuming no voids in the dust core.

### [Difference in Relative Density]

The difference between the highest and the lowest of the relative densities of the body 10, the first plate portion 20, and the second plate portion 30 may be 5.0% or less. When the compact 1 has a small difference in relative density, the physical properties, such as magnetic properties, are substantially uniform in the compact 1. The uniformity of the physical properties is expected to increase as the difference in relative density decreases. The difference in relative density may be 4.0% or less, or 3.0% or less.

### First Embodiment

### [Method of Manufacturing Compact]

### [Mold]

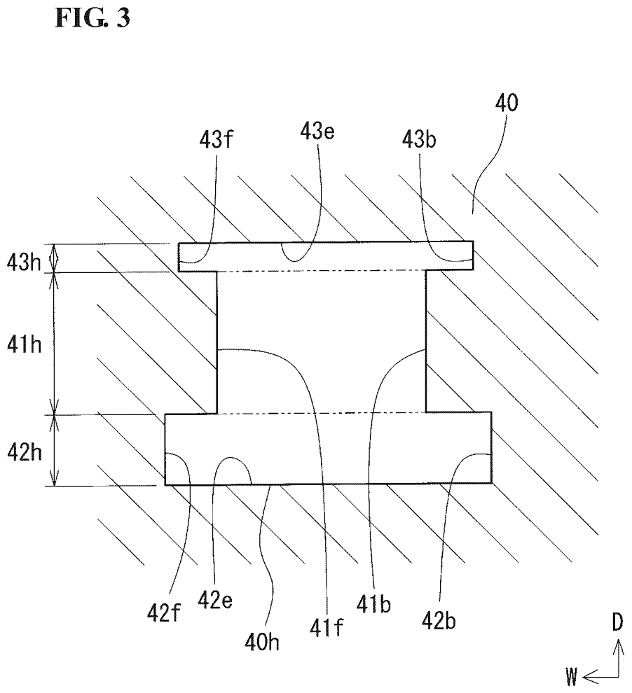

The above-described compact 1 is molded by using a mold 4 illustrated in FIGS. 3 to 6. First, the mold 4 will be described with reference to FIGS. 3 to 6. Then, steps of the manufacturing method will be described. The mold 4 includes a die 40, an upper punch 50, and a lower punch 60. The die 40 has a die hole 40h that extends vertically. The upper punch 50 is vertically movable in the die hole 40h. The lower punch 60 is vertically movable in the die hole 40h.

The directions of the mold 4 are defined as described below. The directions of the mold 4 are shown by arrows in FIGS. 3 to 6.
The vertical direction of the mold 4 is direction H. Direction H is a direction along an axis of the die hole 40h. Direction H is also a direction along axes of the upper punch 50 and the lower punch 60. When the compact 1 is molded, direction Y of the compact 1 is the same as direction H of the mold 4.
When the die hole 40h is viewed in the top-to-bottom direction, direction D is a direction from a first sub-hole 42h that forms the first plate portion 20 to a second sub-hole 43h that forms the second plate portion 30 or a direction opposite thereto. When the compact 1 is molded, direction Z of the compact 1 is the same as direction D of the mold 4.
When the die hole 40h is viewed in the top-to-bottom direction, direction W is a direction orthogonal to direction D or a direction opposite thereto. When the compact 1 is molded, direction X of the compact 1 is the same as direction W of the mold 4.

The dimensions of the mold 4 or the compact 1 in the mold 4 in the respective directions are as follows.

The dimension in direction H is height.

The dimension in direction W is width.

The dimension in direction D is depth.

### (Die)

The die 40 has the die hole 40h. The die hole 40h is a through hole that opens in the upper and lower surfaces of the die 40. The upper punch 50 is fitted to an upper section of the die hole 40h. The lower punch 60 is fitted to a lower section of the die hole 40h. The die hole 40h has a cross-sectional shape corresponding to the shape of the compact 1. The cross-sectional shape is the shape of the die hole 40h in cross-section orthogonal to the axis of the die hole 40h.

As illustrated in FIG. 3, the die hole 40h includes a main hole 41h, the first sub-hole 42h, and the second sub-hole 43h. The main hole 41h is a region of the die hole 40h that forms the body 10. The first sub-hole 42h is a region of the die hole 40h that forms the first plate portion 20. The second sub-hole 43h is a region of the die hole 40h that forms the second plate portion 30. The boundary between the main hole 41h and the first sub-hole 42h is shown by a two-dot chain line. The boundary between the main hole 41h and the second sub-hole 43h is also shown by a two-dot chain line.

The first sub-hole 42h is connected to a first end of the main hole 41h in direction D. The second sub-hole 43h is connected to a second end of the main hole 41h in direction D. The main hole 41h, the first sub-hole 42h, and the second sub-hole 43h are connected to each other.

The main hole 41h has a rectangular shape in cross-section. The first sub-hole 42h has a flat rectangular shape in cross-section. The second sub-hole 43h also has a flat rectangular shape in cross-section. As described above, the rectangular shape includes not only the shape of a geometrical rectangle but also the shape of a rectangle with corners blunted by rounding or chamfering. The rectangle includes elongated rectangles and squares.

The front surface 11 is formed by an inner surface 41f of the main hole 41h orthogonal to direction W. The rear surface 12 is formed by an inner surface 41b of the main hole 41h orthogonal to direction W. The first front surface 21 is formed by an inner surface 42f of the first sub-hole 42h orthogonal to direction W. The first rear surface 22 is formed by an inner surface 42b of the first sub-hole 42h orthogonal to direction W. The second front surface 31 is formed by an inner surface 43f of the second sub-hole 43h orthogonal to direction W. The second rear surface 32 is formed by an inner surface 43b of the second sub-hole 43h orthogonal to direction W. The first end surface 25 is formed by an end surface 42e of the first sub-hole 42h orthogonal to direction D. The second end surface 35 is formed by an end surface 43e of the second sub-hole 43h orthogonal to direction D.

In the example illustrated in FIG. 3, among the main hole 41h, the first sub-hole 42h, and the second sub-hole 43h, the main hole 41h has the greatest depth, the first sub-hole 42h has the second greatest depth, and the second sub-hole 43h has the smallest depth. In this example, among the main hole 41h, the first sub-hole 42h, and the second sub-hole 43h, the first sub-hole 42h has the greatest width, the second sub-hole 43h has the second greatest width, and the main hole 41h has the smallest width. In the example illustrated in FIG. 3, the die hole 40h is H-shaped in cross-section. Typically, the depth of the main hole 41h is greater than the depths of the first sub-hole 42h and the second sub-hole 43h. The depths and widths of the main hole 41h, the first sub-hole 42h, and the second sub-hole 43h are not limited by the above-described dimensional relationships and can be set to any values.

In the example illustrated in FIG. 3, the first sub-hole 42h projects from both sides of the main hole 41h in direction W. The second sub-hole 43h also projects from both sides of the main hole 41h in direction W. However, the first sub-hole 42h may project from only one side of the main hole 41h in direction W The second sub-hole 43h may also project from only one side of the main hole 41h in direction W.

### (Upper Punch)

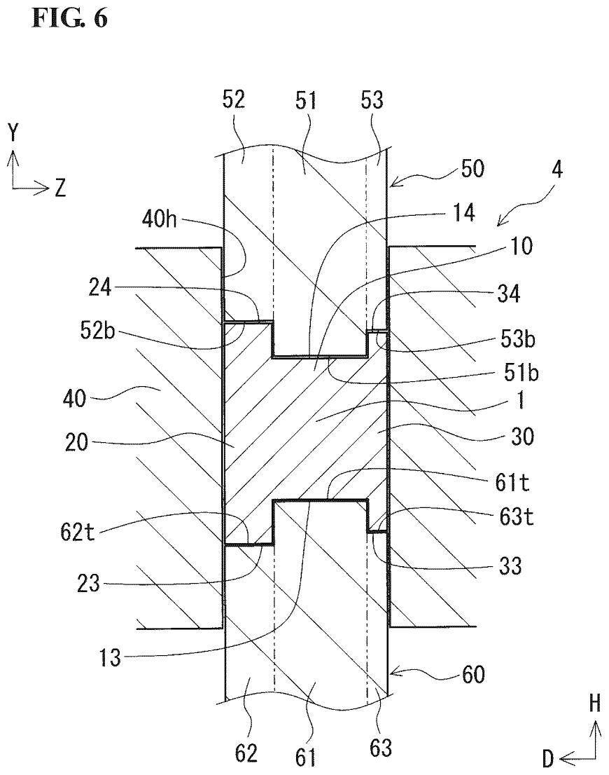

The upper punch 50 can be driven in the up-down direction relative to the compact 1. As illustrated in FIG. 6, the upper punch 50 includes a main upper punch 51, a first upper punch 52, and a second upper punch 53. The main upper punch 51 is fitted to the main hole 41h. The first upper punch 52 is fitted to the first sub-hole 42h. The second upper punch 53 is fitted to the second sub-hole 43h. The shape and dimensions of the main upper punch 51 respectively correspond to the shape and dimensions of the main hole 41h. The shape and dimensions of the first upper punch respectively correspond to the shape and dimensions of the first sub-hole 42h. The shape and dimensions of the second upper punch 53 respectively correspond to the shape and dimensions of the second sub-hole 43h. The main upper punch 51 projects furthest downward, followed by the second upper punch 53 and the first upper punch 52 in that order. The amounts by which the main upper punch 51, the first upper punch 52, and the second upper punch 53 project downward may be adjusted to adjust the lengths by which the first projecting section 20F and the second projecting section 30F project from the body 10.

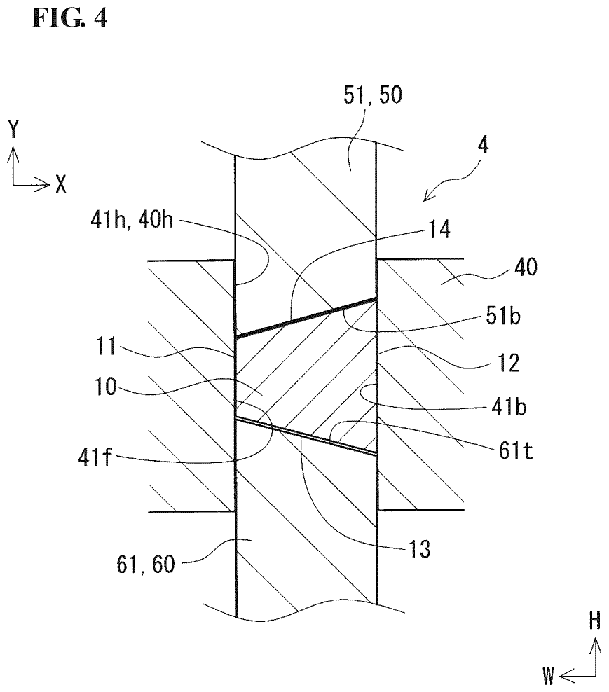

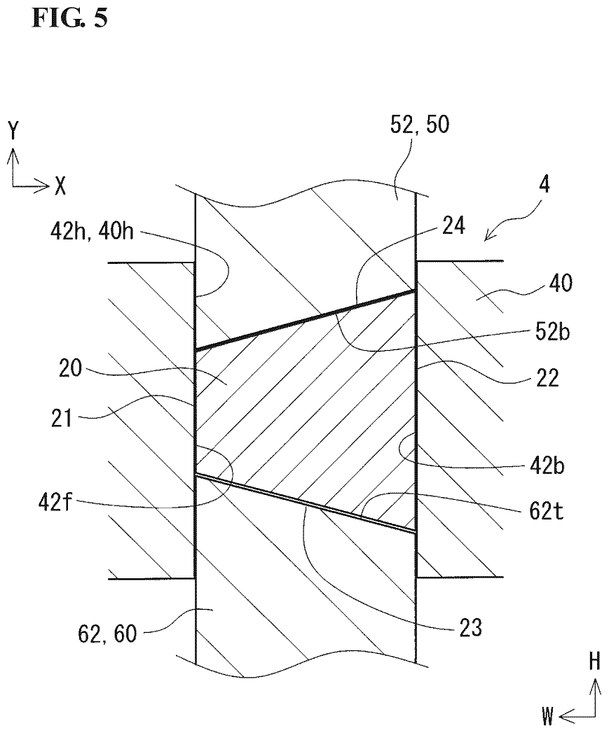

The upper punch 50 has a main lower surface 51b, a first sub-lower surface 52b, and a second sub-lower surface 53b. The main upper punch 51 has the main lower surface 51b. As illustrated in FIG. 4, the main lower surface 51b forms the left side surface 14 of the body 10. The first upper punch 52 has the first sub-lower surface 52b. As illustrated in FIG. 5, the first sub-lower surface 52b forms the first left side surface 24. The second upper punch 53 has the second sub-lower surface 53b. As illustrated in FIG. 6, the second sub-lower surface 53b forms the second left side surface 34. The main lower surface 51b is composed of an oblique surface corresponding to the left side surface 14. The first sub-lower surface 52b is composed of an oblique surface corresponding to the first left side surface 24. The second sub-lower surface 53b is composed of an oblique surface corresponding to the second left side surface 34. These oblique surfaces are disposed to non-orthogonally cross direction W These oblique surfaces may each include a portion extending along direction W at least at one of the ends thereof in direction W. The oblique lower surfaces of the upper punch 50 and the surfaces extending along the axis of the upper punch 50 do not form corners with acute angles, so that damage to the upper punch 50 can be reduced.

The main upper punch 51, the first upper punch 52, and the second upper punch 53 used in this example are formed integrally. Alternatively, two punches selected from the main upper punch 51, the first upper punch 52, and the second upper punch 53 may be formed integrally while the unselected punch is separate from the two punches that are integrated. In particular, when the step between the left side surface 14 and the first left side surface 24 and the step between the right side surface 13 and the second right side surface 33 are large, the main upper punch 51 and the first upper punch 52 may be separate punches. Alternatively, the main upper punch 51 and the second upper punch 53 may be separate punches. The upper punch 50 may be divided into punches along boundary lines shown by two-dot chain lines in FIG. 6.

### (Lower Punch)

The lower punch 60 can be driven in the up-down direction relative to the compact 1. As illustrated in FIG. 6, the lower punch 60 includes a main lower punch 61, a first lower punch 62, and a second lower punch 63. The main lower punch 61 is fitted to the main hole 41h. The first lower punch 62 is fitted to the first sub-hole 42h. The second lower punch 63 is fitted to the second sub-hole 43h. The shape and dimensions of the main lower punch 61 respectively correspond to the shape and dimensions of the main hole 41h. The shape and dimensions of the first lower punch 62 respectively correspond to the shape and dimensions of the first sub-hole 42h. The shape and dimensions of the second lower punch 63 respectively correspond to the shape and dimensions of the second sub-hole 43h. The main lower punch 61 projects furthest upward, followed by the second lower punch 63 and the first lower punch 62. The amounts by which the main lower punch 61, the first lower punch 62, and the second lower punch 63 project upward may be adjusted to adjust the lengths by which the first projecting section 20F and the second projecting section 30F project from the body 10.

The lower punch 60 has a main upper surface 61t, a first sub-upper surface 62t, and a second sub-upper surface 63t. The main lower punch 61 has the main upper surface 61t. As illustrated in FIG. 4, the main upper surface 61t forms the right side surface 13 of the body 10. The first lower punch 62 has the first sub-upper surface 62t. As illustrated in FIG. 5, the first sub-upper surface 62t forms the first right side surface 23. The second lower punch 63 has the second sub-upper surface 63t. As illustrated in FIG. 6, the second sub-upper surface 63t forms the second right side surface 33. The main upper surface 61t is composed of an oblique surface corresponding to the right side surface 13. The first sub-upper surface 62t is composed of an oblique surface corresponding to the first right side surface 23. The second sub-upper surface 63t is composed of an oblique surface corresponding to the second right side surface 33. These oblique surfaces are disposed to non-orthogonally cross direction W. These oblique surfaces may each include a portion extending along direction W at least at one of the ends thereof in direction W. The oblique upper surfaces of the lower punch 60 and the surfaces extending along the axis of the lower punch 60 do not form corners with acute angles, so that damage to the lower punch 60 can be reduced.

The main lower punch 61, the first lower punch 62, and the second lower punch 63 used in this example are formed integrally. Alternatively, two punches selected from the main lower punch 61, the first lower punch 62, and the second lower punch 63 may be formed integrally while the unselected punch is separate from the two punches that are integrated. In particular, when the step between the left side surface 14 and the first left side surface 24 and the step between the right side surface 13 and the second right side surface 33 are large, the main lower punch 61 and the first lower punch 62 may be separate punches. Alternatively, the main lower punch 61 and the second lower punch 63 may be separate punches. The lower punch 60 may be divided into punches along boundary lines shown by two-dot chain lines in FIG. 6.

The lower punch 60 and the upper punch 50 have the same width and depth. The main lower punch 61 and the main upper punch 51 have the same width and depth. The first lower punch 62 and the first upper punch 52 have the same width and depth. The second lower punch 63 and the second upper punch 53 have the same width and depth. In the molding process, the lower punch 60 does not locally press the compact 1, so that the compact 1 can be reduced from receiving a shear stress.

### (Steps of Manufacturing Method)

The above-described compact 1 is obtained by a method of manufacturing the compact 1 including a filling step, a molding step, and a demolding step.

### [Filling Step]

In the filling step, the space defined by the die hole 40h in the die 40 and the lower punch 60 is filled with powder. The powder may be the above-described soft magnetic powder or coated soft magnetic powder. The powder may include a binder or a lubricant in addition to the soft magnetic powder or the coated soft magnetic powder. A lubricant may be applied to the inner peripheral surface of the die hole 40h.

### [Molding Step]

In the molding step, the powder in the space is compressed by the lower punch 60 and the upper punch 50. The direction in which the powder in the space is compressed is direction Y of the compact 1. The higher the pressure in the compression molding process, the higher the relative density of the manufactured compact 1. The above-described pressure is, for example, 700 MPa or more, or 980 MPa or more.

### [Demolding Step]

In the demolding step, the die 40, the upper punch 50, and the lower punch 60 are relatively moved in the up-down direction to remove the compact 1 from the die hole 40h. In this case, the lower punch 60 does not locally press the compact 1, so that the compact 1 can be reduced from receiving a shear stress when demolded. As a result, damage, such as chipping or cracking, to the compact 1 can be reduced.

### [Other Steps]

After the demolding step, the compact 1 may be subjected to heat treatment as necessary. For example, a heat treatment for correcting the distortion of the compact 1 may be performed to manufacture a low-loss compact 1. Alternatively, for example, a heat treatment may be performed to remove the binder or lubricant. When the powder contains the above-described coated soft magnetic particles, the heat treatment temperature may be, for example, the decomposition temperature of the insulating coating or less.

### Second Embodiment

### [Method of Manufacturing Stator Core]

A method of manufacturing the stator core 70 according to a second embodiment will now be described mainly with reference to FIG. 7. To manufacture the stator core 70 according to the present embodiment, compacts 1 to be arranged annularly are used. Each of the compacts 1 is the compact 1 obtained by the method of manufacturing a compact according to the first embodiment. To manufacture the stator core 70, a first compact 1a and a second compact 1b of the compacts 1 are arranged by bringing the first right side surface 23 of the first compact 1a and the first left side surface 24 of the second compact 1b into contact with each other. The compacts 1 are arranged by successively bringing the first right side surface 23 and the first left side surface 24 of adjacent ones of the compacts 1 into contact with each other. Thus, the compacts 1 are assembled into an annular form, and the stator core 70 can be easily obtained. The stator core 70 is used in the DS/SR axial gap motor 9 illustrated in FIG. 8.

The variation in the length between the first end surface 25 and the second end surface 35 between the compacts 1 may be 0.1 mm or less. The length between the first end surface 25 and the second end surface 35 is the maximum value of the length between the first end surface 25 and the second end surface 35 in direction Z.

When the variation in the length between the first end surface 25 and the second end surface 35 is 0.1 mm or less, the variation in the above-described length is very small. By using the stator core 70 in which the variation in the length between the first end surface 25 and the second end surface 35 is 0.1 mm or less, the axial gap motor 9 with small noise and vibration can be obtained. The reason for this is as follows. As illustrated in FIG. 8, in the axial gap motor 9, each stator 7 and the rotor 90 are arranged to face each other. When the variation in the above-described length of the stator core 70 is small, the variation in the gap between each stator 7 and the rotor 90 is small. When the variation in the above-described gap is small, the torque ripple is small. When the torque ripple is small, the noise and vibration are not easily increased. The variation in the above-described length can be determined as follows. The length from the first end surface 25 to the second end surface 35 is measured for each compact 1. The length is the maximum length of the compact 1 in direction Z. The difference between the greatest and smallest of the above-described lengths of the compacts 1 is calculated. This difference is determined as the variation in the above-described length. The variation in the length between the first end surface 25 and the second end surface 35 may be 0.05 mm or less, or 0.01 mm or less. The length between the first end surface 25 and the second end surface 35 is the average of values measured at three or more points with a micro gauge.

### <<Axial Gap Motor a Including Compacts>>

The axial gap motor 9 including the compacts 1 will now be described with reference to FIG. 8. FIG. 8 is a sectional view of the axial gap motor 9 taken along a plane parallel to a rotating shaft 91 and including axes of stator cores. This also applies to FIG. 9 illustrating the axial gap motor 9a described below. The axial gap motor 9 is of a DS/SR type and includes single rotor 90 and double stators 7. In the axial gap motor 9, the rotor 90 and each stator 7 are arranged to face each other in the direction along an axis. The rotor 90 is sandwiched between the double stators 7. Each stator 7 includes compacts 1 and coils 80. The compacts 1 are annularly arranged. Each coil 80 is wound around the body 10 of the corresponding compact 1. The coil 80 is, for example, a wound wire composed of a conductor wire made of a good conductor, such as copper. Each stator 7 may include the above-described stator core 70. The axial gap motor 9 may be used as a motor or a generator. The axial gap motor 9 includes a case 92.

The case 92 has a cylindrical internal space that accommodates the stators 7 and the rotor X). The case 92 includes a cylindrical portion 921 and two plate portions 922. The cylindrical portion 921 surrounds the outer peripheries of the stators 7 and the rotor 90. The plate portions 922 are disposed at both ends of the cylindrical portion 921. The two plate portions 922 are fixed to respective end surfaces of the cylindrical portion 921 so as to sandwich the stators 7 and the rotor 90 from the front and back. The plate portions 922 each have a through hole at the center thereof. Bearings 93 are provided in the through holes. The rotating shaft 91 is inserted through the bearings 93 in the through holes. The rotating shaft 91 extends through the case 92.

The rotor 90 includes magnet 95 and a rotor body (not illustrated). The rotor 90 is a flat plate-shaped member. The magnet 95 may be multiple or may be one. When multiple magnets 95 are provided, the number of magnets 95 may be the same as the number of compacts 1. The magnets 95 are arranged around the axis of the rotor 90 at equal intervals. In the present embodiment, each magnet 95 is flat-plate-shaped, and the shape thereof in plan view corresponds to that of the second end surface 35 of each compact 1. Each magnet 95 may have the shape of a convex lens having a surface convex toward each stator 7. When one magnet 95 is provided, the magnet 95 has an annular shape. The magnet 95 has S and N poles arranged alternately around an axis. The rotor body supports the magnets 95. The rotor body is an annular member. The rotor body is rotatably supported by the rotating shaft 91. Each magnet 95 is evenly spaced around the axis of the rotor body. Each magnet 95 is magnetized in a direction along the axis of the rotating shaft 91. The magnets 95 that are adjacent to each other around the axis of the rotor body are magnetized in opposite directions. The stators 7 generate rotating magnetic fields that cause the magnets 95 to repeatedly attract and repel the compacts 1, thereby rotating the rotor 90.

Each stator 7 is disposed such that the first plate portions 20 of the compacts 1 face the corresponding plate portion 922. The second end surfaces 35 of the second plate portions 30 face the magnets 95 of the rotor 90. When the rotor 90 rotates, the second end surfaces 35 of the compacts 1 receive magnetic flux from the magnets 95 that rotate. When the second end surfaces 35 of the compacts 1 are convex, the noise and vibration of the axial gap motor 9 can be reduced. The reason for this is as follows. When the second end surfaces 35 of the compacts 1 are convex, sudden changes in the magnetic flux of the magnets 95 received by the compacts 1 are easily suppressed. Therefore, the cogging torque can be easily reduced. When the cogging torque is small, the noise and vibration are not easily increased.

### <<Axial Gap Motor B Including Compacts>>

The axial gap motor 9a will now be described with reference to FIG. 9. The axial gap motor 9a differs from the axial gap motor 9 illustrated in FIG. 8 in that the axial gap motor 9a is of an SS/DR type that mainly includes double rotors 90a and single stator 7a In the axial gap motor 9a, each rotor 90a and the stator 7a face each other in a direction along the axis. The stator 7a is sandwiched between the double rotors 90a. In the following description, differences from the axial gap motor 9 illustrated in FIG. 8 will be mainly described. Description of structures similar to those of the axial gap motor 9 illustrated in FIG. 8 will be omitted.

Each rotor 90a includes a rotor body (not illustrated), multiple magnets 95, and a back yoke 98. The rotor body and the multiple magnets 95 are described above. The back yoke 98 is disposed between the rotor 90a and the corresponding plate portion 922. The back yoke 98 is a flat plate-shaped member. The composition of the back yoke 98 is the same as that of the above-described compact 1. Alternatively, the back yoke 98 is composed of a multilayer steel plate.

The stator 7a includes compacts 1c that are arranged annularly, coils 80 wound around the bodies 10 of the respective compacts 1c, and a support member that holds the compacts 1c. The support member is not illustrated. Although the structures are simplified in FIG. 9, the first plate portion 20a and the second plate portion 30a of each compact 1c have the same structure. In each compact 1c, the amount by which the first projecting section 20F of the first plate portion 20a project is equal to the amount by which the second projecting section 30F of the second plate portion 30a project. The coils 80 are similar to those in the above-described axial gap motor 9 illustrated in FIG. 8. The support member holds the compacts 1c so that the intervals between the compacts 1a that are adjacent to each other are equal. The support member prevents adjacent ones of the compacts 1c from coming into contact with each other.

The present invention is not limited to the above examples but is defined by the claims, and is intended to include all modifications within the meaning and scope equivalent to the claims. For example, the axial gap motor may include one rotor and one stator.

### REFERENCE SIGNS LIST

1, 1c compact
1a first compact
1b second compact
10 body
11 front surface, 12 rear surface, 13 right side surface, 14 left side surface
20, 20a first plate portion
21 first front surface, 22 first rear surface, 23 first right side surface, 24 first left side surface
25 first end surface, 20F first projecting section
30, 30a second plate portion
31 second front surface, 32 second rear surface, 33 second right side surface,
34 second left side surface
35 second end surface, 30F second projecting section
4 mold
40 die
40h die hole, 41h main hole, 42h first sub-hole, 43h second sub-hole
41f, 41b, 42f, 42b, 43f, 43b inner surface
42e, 43e end surface
50 upper punch
51 main upper punch, 52 first upper punch, 53 second upper punch
51b main lower surface, 52b first sub-lower surface, 53b second sub-lower surface
60 lower punch
61 main lower punch, 62 first lower punch, 63 second lower punch
61t main upper surface, 62t first sub-upper surface, 63t second sub-upper surface
7, 7a stator, 70 stator core, 80 coil
9, 9a axial gap motor
90 rotor, 91 rotating shaft, 92 case
921 cylindrical portion, 922 plate portion, 93 bearing, 95 magnet, 98 back yoke

1. A method of manufacturing a compact, the method comprising:
filling a space defined by a die hole in a die and a lower punch with powder; and
compressing the powder in the space with the lower punch and an upper punch to form a compact,
wherein the compact includes
a body, the body being prism-shaped and having a first bottom surface, a second bottom surface opposite to the first bottom surface, and a plurality of side surfaces,
a first plate portion provided on the first bottom surface, and
a second plate portion provided on the second bottom surface,
wherein the plurality of side surfaces include
a front surface and a rear surface, the front surface and the rear surface extending parallel to each other along an axis of the body, and
a left side surface and a right side surface, the left side surface connecting the front surface and the rear surface, the right side surface connecting the front surface and the rear surface,
wherein the first plate portion includes
a first projecting section projecting from the body in a direction orthogonal to the axis,
a first front surface and a first rear surface, the first front surface and the first rear surface extending parallel to each other along the axis, and
a first left side surface and a first right side surface, the first left side surface connecting the first front surface and the first rear surface, the first right side surface connecting the first front surface and the first rear surface,
wherein the first left side surface and the first right side surface include oblique regions in which a gap between the first left side surface and the first right side surface increases from the first front surface toward the first rear surface,
wherein the second plate portion includes
a second projecting section projecting from the body in a direction orthogonal to the axis,
a second front surface and a second rear surface, the second front surface and the second rear surface extending parallel to each other along the axis, and
a second left side surface and a second right side surface, the second left side surface connecting the second front surface and the second rear surface, the second right side surface connecting the second front surface and the second rear surface,
wherein the upper punch includes
a main lower surface configured to form the left side surface of the body,
a first sub-lower surface configured to form the first left side surface of the first plate portion, and
a second sub-lower surface configured to form the second left side surface of the second plate portion, and
wherein the lower punch includes
a main upper surface configured to form the right side surface of the body,
a first sub-upper surface configured to form the first right side surface of the first plate portion, and
a second sub-upper surface configured to form the second right side surface of the second plate portion.

2. The method of manufacturing a compact according to claim 1, wherein the left side surface and the right side surface are oblique such that a gap between the left side surface and the right side surface increases from the front surface toward the rear surface.

3. The method of manufacturing a compact according to claim 1, wherein the second left side surface and the second right side surface include oblique regions in which a gap between the second left side surface and the second right side surface increases from the second front surface toward the second rear surface.

4. The method of manufacturing a compact according to claim 1, wherein the first projecting section projects from the body over an entire periphery of the body around the axis.

5. The method of manufacturing a compact according to claim 1, wherein the second projecting section projects from the body over an entire periphery of the body around the axis.

6. The method of manufacturing a compact according to claim 1, wherein the powder is magnetic powder.

7. A method of manufacturing a stator core, the method comprising:
manufacturing a plurality of compacts by the method of manufacturing a compact according to claim 1; and
forming an annular stator core by arranging the plurality of compacts such that adjacent ones of the plurality of compacts have the first left side surface and the first right side surface facing parallel to each other.

8. A method of manufacturing an axial gap motor, the method comprising:
manufacturing a stator core by the method of manufacturing a stator core according to claim 7; and
assembling the stator core and a rotor together.

9. The method of manufacturing a compact according to claim 2, wherein the second left side surface and the second right side surface include oblique regions in which a gap between the second left side surface and the second right side surface increases from the second front surface toward the second rear surface.

10. The method of manufacturing a compact according to claim 2, wherein the first projecting section projects from the body over an entire periphery of the body around the axis.

11. The method of manufacturing a compact according to claim 3, wherein the first projecting section projects from the body over an entire periphery of the body around the axis.

12. The method of manufacturing a compact according to claim 2, wherein the second projecting section projects from the body over an entire periphery of the body around the axis.

13. The method of manufacturing a compact according to claim 3, wherein the second projecting section projects from the body over an entire periphery of the body around the axis.

14. The method of manufacturing a compact according to claim 4, wherein the second projecting section projects from the body over an entire periphery of the body around the axis.

15. The method of manufacturing a compact according to claim 2, wherein the powder is magnetic powder.

16. The method of manufacturing a compact according to claim 3, wherein the powder is magnetic powder.

17. The method of manufacturing a compact according to claim 3, wherein the powder is magnetic powder.

18. The method of manufacturing a compact according to claim 4, wherein the powder is magnetic powder.

19. The method of manufacturing a compact according to claim 5, wherein the powder is magnetic powder.

20. A method of manufacturing a stator core, the method comprising:
manufacturing a plurality of compacts by the method of manufacturing a compact according to claim 2; and
forming an annular stator core by arranging the plurality of compacts such that adjacent ones of the plurality of compacts have the first left side surface and the first right side surface facing parallel to each other.
